(19) United States
(12) Patent Application Publication
(10) Pub. No.: US 2010/0045910 A1
(43) Pub. Date: Feb. 25, 2010

(54) LAMINATED OPTICAL FILM, AND LIQUID CRYSTAL PANEL AND LIQUID CRYSTAL DISPLAY APPARATUS USING THE LAMINATED OPTICAL FILM

(75) Inventors: Masato Bitou, Ibaraki-shi (JP); Shunsuke Shutou, Ibaraki-shi (JP); Misaki Sabae, Ibaraki-shi (JP); Ikuo Kawamoto, Ibaraki-shi (JP); Hironori Motomura, Ibaraki-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Ibaraki-shi, Osaka (JP)

(21) Appl. No.: 12/513,389

(22) PCT Filed: Oct. 23, 2007
(86) PCT No.: PCT/JP2007/070585

§ 371 Date: Jul. 13, 2009

(30) Foreign Application Priority Data
Nov. 20, 2006 (JP) 2006-312575
Feb. 14, 2007 (JP) 2007-033031

(51) Int. Cl. G02F 1/13363; G02B 5/30

(52) U.S. Cl. 349/118; 359/499

(57) ABSTRACT

An object of the present invention is to provide a laminated optical film, a liquid crystal panel, and a liquid crystal display apparatus that have an excellent screen contrast and have a small color shift.

A laminated optical film of the present invention includes in this order: a polarizer; a first optical compensation layer that has a refractive index ellipsoid exhibiting a relationship of nx>ny=nz and an in-plane retardation Re₁ of 80 to 300 nm; a second optical compensation layer that has a refractive index ellipsoid exhibiting a relationship of nz>nx=ny; and a third optical compensation layer that has a refractive index ellipsoid exhibiting a relationship of nx>ny=nz and an in-plane retardation Re₃ of 80 to 200 nm, wherein an absorption axis of the polarizer is perpendicular to a slow axis of the first optical compensation layer.

### TECHNICAL FIELD

The present invention relates to a laminated optical film, and a liquid crystal panel and a liquid crystal display apparatus using the laminated optical film. More specifically, the present invention relates to a laminated optical film having a polarizer and at least three optical compensation layers, and a liquid crystal panel and a liquid crystal display apparatus using the laminated optical film.

### BACKGROUND ART

In a liquid crystal display apparatus, generally, various optical films including a combination of a polarizing film and an optical compensation layer are used so as to perform optical compensation.

A circularly polarizing plate that is one kind of the optical films can be generally produced by combining a polarizing film and a λ/4 plate. However, the λ/4 plate exhibits the property in which a retardation value increases toward a shorter wavelength side, a so-called “positive wavelength dispersion property”, and generally has a large wavelength dispersion property. Therefore, there is a problem in that desired optical properties (for example, the function as the λ/4 plate) cannot be exhibited over a wide wavelength range. In order to avoid such a problem, as a retardation plate exhibiting the wavelength dispersion property in which a retardation value increases toward a longer wavelength side (a so-called “reverse wavelength dispersion property”), for example, a modified cellulose-based film and a modified polycarbonate-based film have been proposed. However, those films have a problem in terms of a cost.

Currently, regarding the λ/4 plate having a positive wavelength dispersion property, for example, a retardation plate in which a retardation value increases toward a longer wavelength side, and a method of correcting the wavelength dispersion property of the λ/4 plate by combining λ/2 plates are adopted (for example, see Patent Document 1). However, those techniques are insufficient for both the enhancement of a screen contrast and the reduction of a color shift.

### Patent Document 1: JP 3174367 B

### DISCLOSURE OF THE INVENTION

### Problem to be Solved by the Invention

The present invention has been made in view of solving the above-mentioned conventional problems, and an object of the present invention is therefore to provide a laminated optical film, a liquid crystal panel, and a liquid crystal display apparatus that have an excellent screen contrast and have a small color shift.

### Means for Solving the Problems

In one embodiment, a laminated optical film of the present invention includes in this order: a polarizer; a first optical compensation layer that has a refractive index ellipsoid exhibiting a relationship of nx>ny=nz and an in-plane retardation Re₁ of 80 to 300 nm; a second optical compensation layer that has a refractive index ellipsoid exhibiting a relationship of nz>nx=ny; and a third optical compensation layer that has a refractive index ellipsoid exhibiting a relationship of nx>ny=nz and an in-plane retardation Re₃ of 80 to 200 nm, wherein an absorption axis of the polarizer is perpendicular to a slow axis of the first optical compensation layer.

In another embodiment, a laminated optical film of the present invention includes in this order: a polarizer; a first optical compensation layer that has a refractive index ellipsoid exhibiting a relationship of nx>ny>nz and an in-plane retardation Re₁ of 80 to 300 nm; a second optical compensation layer that has a refractive index ellipsoid exhibiting a relationship of nz>nx=ny; and a third optical compensation layer that has a refractive index ellipsoid exhibiting a relationship of nx>ny=nz and an in-plane retardation Re₃ of 80 to 200 nm, wherein an absorption axis of the polarizer is perpendicular to a slow axis of the first optical compensation layer.

In a preferred embodiment, the laminated optical film further includes a fourth optical compensation layer that is placed on a side of the third optical compensation layer opposite to the second optical compensation layer and has a refractive index ellipsoid exhibiting a relationship of nx=ny>nz.

According to another aspect of the present invention, a liquid crystal panel is provided. The liquid crystal panel includes a liquid crystal cell and the laminated optical film.

In a preferred embodiment, the laminated optical film is placed on a backlight side.

In a preferred embodiment, the liquid crystal panel includes a laminated film including a polarizer and a fifth optical compensation layer that has a refractive index ellipsoid exhibiting a relationship of nx>ny=nz and an in-plane retardation Re₅ of 80 to 200 nm on a viewer side.

In a preferred embodiment, the liquid crystal cell is in a VA mode.

According to still another aspect of the present invention, a liquid crystal display apparatus is provided. The liquid crystal display apparatus has the liquid crystal panel.

### EFFECTS OF THE INVENTION

As described above, according to the present invention, a first optical compensation layer, a second optical compensation layer, and a third optical compensation layer having the above optical properties are placed at a predetermined angle, whereby a screen contrast can be enhanced and a color shift can be reduced.

### BRIEF DESCRIPTION OF THE DRAWINGS

FIG. 1 (a) is a schematic cross-sectional view of a laminated optical film according to one embodiment of the present invention and (b) is a schematic cross-sectional view of a laminated optical film according to another preferred embodiment of the present invention.

FIG. 2 (a) is a schematic cross-sectional view of a liquid crystal panel according to one embodiment of the present invention and (b) is a schematic cross-sectional view of a liquid crystal panel according to another preferred embodiment of the present invention.

FIG. 3 A schematic cross-sectional view illustrating an alignment state of liquid crystal molecules in a liquid crystal layer in the case where a liquid crystal cell in a VA mode is adopted in a liquid crystal display apparatus of the present invention.

FIG. 4 The results of a computer simulation regarding viewing angle dependence of a contrast of a liquid crystal panel in Example 1 of the present invention.

FIG. 5 A contrast contour map showing viewing angle dependence of a contrast of the liquid crystal panel in Example 1 of the present invention.

FIG. 6 The results of a computer simulation regarding viewing angle dependence of a contrast of a liquid crystal panel in Example 2 of the present invention.

FIG. 7 A contrast contour map showing viewing angle dependence of a contrast of the liquid crystal panel in Example 2 of the present invention.

FIG. 8 The results of a computer simulation regarding viewing angle dependence of a contrast of a liquid crystal panel in Example 3 of the present invention.

FIG. 9 A contrast contour map showing viewing angle dependence of a contrast of the liquid crystal panel in Example 3 of the present invention.

FIG. 10 The results of a computer simulation regarding viewing angle dependence of a contrast of a liquid crystal panel in Comparative Example 1.

FIG. 11 A contrast contour map showing viewing angle dependence of a contrast of the liquid crystal panel in Comparative Example 1.

FIG. 12 The results of a computer simulation regarding viewing angle dependence of a contrast of a liquid crystal panel in Comparative Example 2.

FIG. 13 A contrast contour map showing viewing angle dependence of a contrast of the liquid crystal panel in Comparative Example 2.

FIG. 14 The results of a computer simulation regarding viewing angle dependence of a contrast of a liquid crystal panel in Comparative Example 3.

### DESCRIPTION OF SYMBOLS

10 laminated optical film
10′ laminated optical film
11 polarizer
12 first optical compensation layer
13 second optical compensation layer
14 third optical compensation layer
15 fourth optical compensation layer
20 liquid crystal cell
100 liquid crystal panel
100′ liquid crystal panel

### BEST MODE FOR CARRYING OUT THE INVENTION

Hereinafter, although the present invention will be described by way of a preferred embodiment, the present invention is not limited thereto.

### DEFINITIONS OF TERMS AND SYMBOLS

The definitions of terms and symbols used in the present specification are as follows.

(1) Refractive Index (nx, ny, nz)

“nx” denotes a refractive index in a direction (i.e., a slow axis direction) in which a refractive index in a plane is maximum, “ny” denotes a refractive index in a direction perpendicular to a slow axis in the plane, and “nz” denotes a refractive index in a thickness direction.

(2) In-Plane Retardation (Re)

An in-plane retardation (Re) refers to an in-plane retardation value of a layer (film) at a wavelength of 590 nm at 23° C. unless otherwise specified. Re is obtained by Re=(nx−ny)×d, when d (nm) is a thickness of a layer (film). In this specification, Re(550) refers to an in-plane retardation of a layer (film) at a wavelength of 550 nm. Further, the subscript “1” attached to a term or symbol described in this specification represents a first optical compensation layer, the subscript “2” represents a second optical compensation layer, the subscript “3” represents a third optical compensation layer, and the subscript “4” represents a fourth optical compensation layer. For example, an in-plane retardation of the first optical compensation layer is represented by Re₁.

(3) Thickness Direction Retardation (Rth)

A thickness direction retardation (Rth) refers to a retardation value in a thickness direction of a layer (film) at a wavelength of 590 nm at 23° C. unless otherwise specified. Rth is obtained by Rth=(nx−nz)×d, when d (nm) is a thickness of a layer (film). In this specification, Rth(550) refers to a thickness direction retardation of a layer (film) at a wavelength of 550 nm. Further, for example, a thickness direction retardation of the first optical compensation layer is represented by Rth₁ in this specification.

(4) Nz Coefficient

An Nz coefficient is obtained by Nz=Rth/Re.

(5) λ/2 Plate

A λ/2 plate refers to an electrooptic birefringent plate that rotates a polarization plane of a light beam, which has a function of causing an optical path difference of a ½ wavelength between linear polarized light beams that vibrate in directions perpendicular to each other. More specifically, the μ/2 plate refers to a plate that functions so that the phase between an ordinary ray component and an extraordinary ray component is shifted by a ½ cycle.

(6) λ/4 Plate

A λ/4 plate refers to an electrooptic birefringent plate that rotates a polarization plane of a light beam, which has a function of causing an optical path difference of a ¼ wavelength between linear polarized light beams that vibrate in directions perpendicular to each other. More specifically, the λ/4 plate refers to a plate that functions so that the phase between an ordinary ray component and an extraordinary ray component is shifted by a ¼ cycle and converts circular polarized light into plane polarized light (or plane polarized light into circular polarized light).

A. Laminated Optical Film

A-1. Whole Configuration of Laminated Optical Film

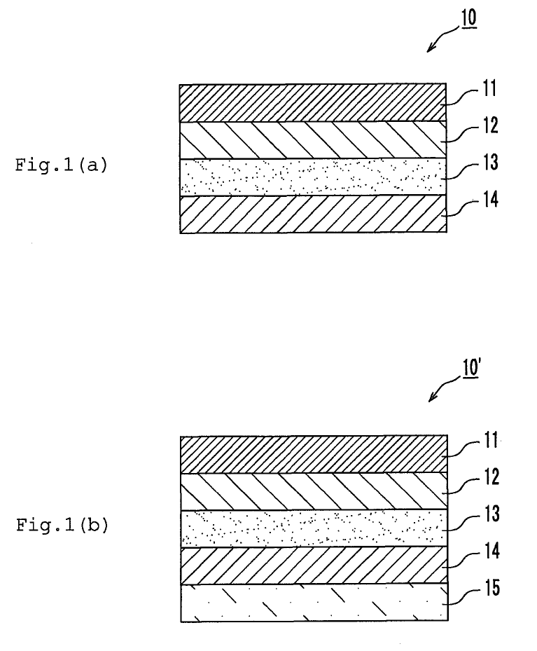

FIG. 1(a) is a schematic cross-sectional view of a laminated optical film according to a preferred embodiment of the present invention. A laminated optical film 10 includes a polarizer 11, a first optical compensation layer 12, a second optical compensation layer 13, and a third optical compensation layer 14 in this order. FIG. 1(b) is a schematic cross-sectional view of a laminated optical film according to another preferred embodiment of the present invention. A laminated optical film 10′ includes the polarizer 11, the first optical compensation layer 12, the second optical compensation layer 13, and the third optical compensation layer 14 in this order. The laminated optical film 10′ further includes a fourth optical compensation layer 15. In the illustrated example, the fourth optical compensation layer 15 is placed on a side of the third optical compensation layer 14 opposite to the second optical compensation layer 13. Although not shown in FIGS. 1(a) and 1(b), if required, a first protective layer is provided between the polarizer 11 and the first optical compensation layer 12, and a second protective layer is provided on a side of the polarizer 11 opposite to the first optical compensation layer 12. In the case where the first protective layer is not provided, the first optical compensation layer 12 can also function as the protective layer of the polarizer 11. The first optical compensation layer functions as a protective layer, which can contribute to the reduction in thickness of a laminated optical film (ultimately, a liquid crystal panel). Further, the laminated optical film of the present invention can further include any suitable optical compensation layer, if required.

The first optical compensation layer 12 has a slow axis, and is laminated so that the slow axis thereof is perpendicular to an absorption axis of the polarizer 11. As used herein, the term “perpendicular” also includes the case of being substantially perpendicular. Here, the phrase “substantially perpendicular” includes the case where two axes form an angle of 90°±3.0°, preferably 90°+±1.0°, and more preferably 90°±0.5°. The third optical compensation layer 14 has a refractive index ellipsoid of nx>ny=nz.

The third optical compensation layer 14 is laminated so that the slow axis thereof defines any suitable angle with respect to the absorption axis of the polarizer 11. The angle is preferably 30 to 60°, more preferably 35 to 55°, particularly preferably 40 to 50°, and most preferably 43 to 47°.

The total thickness of the laminated optical film of the present invention is preferably 250 to 410 μm, more preferably 255 to 405 μm, and particularly preferably 260 to 400 μm. Hereinafter, the detail of each layer constituting the laminated optical film of the present invention will be described.

A-2-1. First Optical Compensation Layer (1)

In one embodiment, the first optical compensation layer 12 has a refractive index ellipsoid of nx>ny=nz. Here, “ny=nz” includes not only the case where ny and nz are strictly equal to each other but also the case where ny and nz are substantially equal to each other. More specifically, the expression “ny=nz” refers to the case where a Nz coefficient (Rth₁/Re₁) is more than 0.9 and less than 1.1. The in-plane retardation Re₁ of the first optical compensation layer is 80 to 300 nm, preferably 80 to 200 nm, and more preferably 100 to 180 nm, and particularly preferably 120 to 160 nm. The first optical compensation layer can compensate for an optical axis of the polarizer. As described above, the screen contrast when viewed from an oblique direction can be enhanced by placing the first optical compensation layer so that the slow axis thereof is perpendicular to an absorption axis of the polarizer. Thus, it is one feature of the present invention that the first optical compensation layer is placed so that the slow axis thereof is perpendicular to the absorption axis of the polarizer.

As a material forming the first optical compensation layer having a refractive index ellipsoid of nx>ny=nz, any suitable material can be adopted as long as the above properties can be obtained. A liquid crystal material is preferred, and a liquid crystal material (nematic liquid crystal) having a liquid crystal phase of a nematic phase is more preferred. By using the liquid crystal material, the difference between nx and ny of an optical compensation layer to be obtained can be increased remarkably compared with that of a non-liquid crystal material. Consequently, the thickness of an optical compensation layer for obtaining a desired in-plane retardation can be decreased remarkably, which can contribute to the reduction in thickness of a laminated optical film and a liquid crystal panel to be obtained. As such a liquid crystal material, for example, a liquid crystal polymer and a liquid crystal monomer can be used. The expression mechanism of liquid crystallinity of the liquid crystal material may be a lyotropic type or a thermotropic type. The alignment state of liquid crystal is preferably homogeneous alignment. The liquid crystal polymer and the liquid crystal monomer may be respectively used alone or in combination.

In the case where the liquid crystal material is a liquid crystalline monomer, it is preferred that the liquid crystalline monomer is, for example, a polymerizable monomer and/or cross-linkable monomer. This is because the alignment state of the liquid crystalline monomer can be fixed by polymerizing or cross-linking the liquid crystalline monomer. When the liquid crystalline monomers are aligned and then, for example, polymerized or cross-linked with each other, the above alignment state can be fixed. A polymer is formed by the polymerization and a three-dimensional network structure is formed by the cross-linking, both of which are non-liquid crystalline. Thus, in the formed first optical compensation layer, for example, a phase transition between a liquid crystal phase, a glass phase, and a crystal phase due to a change in temperature inherent in a liquid crystalline compound is not occurred. As a result, the formed first optical compensation layer becomes an optical compensation layer, which is remarkably excellent in stability, and is not influenced by a change in temperature.

Specific examples of the liquid crystal monomer and the method of forming the first optical compensation layer include the monomer and the forming method described in JP 2006-178389 A.

The thickness of the first optical compensation layer can be set so as to obtain desired optical characteristics. In the case where the first optical compensation layer is formed of a liquid crystal material, the thickness thereof is preferably 0.5 to 10 μm, more preferably 0.5 to 8 μm, and particularly preferably 0.5 to 5 μm.

The first optical compensation layer having a refractive index ellipsoid of nx>ny=nz can also be formed by stretching a polymer film. Specifically, the first optical compensation layer having the desired optical characteristics (for example, a refractive index ellipsoid, an in-plane retardation, a thickness direction retardation) can be obtained by appropriately selecting the kind of a polymer, stretching conditions (for example, a stretching temperature, a stretching ratio, a stretching direction), a stretching method, and the like. More specifically, the stretching temperature is preferably 110 to 170° C. and more preferably 130 to 150° C. The stretching ratio is preferably 1.37 to 1.67 times and more preferably 1.42 to 1.62 times. An example of the stretching method is transverse uniaxial stretching method.

In the case where the first optical compensation layer is formed by stretching a polymer film, the thickness of the first optical compensation layer is preferably 5 to 70 μm, more preferably 10 to 65 μm, and particularly preferably 15 to 60 μm.

As a resin forming the polymer film, any suitable resin can be adopted. Specific examples thereof include resins constituting a positive birefringence film, such as a norbornene-based resin, a polycarbonate-based resin, a cellulose-based resin, a polyvinyl alcohol-based resin, a polysulphone-based resin. Of those, the norbornene-based resin and the polycarbonate-based resin are preferred.

The above norbornene-based resin is obtained by polymerizing a norbornene-based monomer as a polymerization unit. Examples of the norbornene-based monomer include: norbornene, and its alkyl and/or alkylidene-substituted monomers such as 5-methyl-2-norbornene, 5-dimethyl-2-norbornene, 5-ethyl-2-norbornene, 5-butyl-2-norbornene, 5-ethylidene-2-norbornene, and substituted monomers of norbornene and its alkyl and/or alkylidene-substituted monomers with a polar group such as halogen; dicyclopentadiene, 2,3-dihydrodicyclopentadiene, or the like; dimethanooctahydronaphthalene, its substituted monomers with alkyl and/or alkylidene, and its substituted monomers with a polar group such as halogen, such as 6-methyl-1,4:5,8-dimethano-1,4,4a,5,6,7,8,8a-octahydronaphthalene, 6-ethyl-1,4:5,8-dimethano-1,4,4a,5,6,7,8,8a-octahydronaphthalene, 6-ethyliden-1,4:5,8-dimethano-1,4,4a,5,6,7,8,8a-octahydronaphthalene, 6-chloro-1,4:5,8-dimethano-1,4,4a,5,6,7,8,8a-octahydronaphthalene, 6-cyano-1,4:5,8-dimethano-1,4,4a,5,6,7,8,8a-octahydronaphthalene, 6-pyridyl-1,4:5,8-dimethano-1,4,4a,5,6,7,8,8a-octahydronaphthalene, and 6-methoxycarbonyl-1,4:5,8-dimethano-1,4,4a,5,6,7,8,8a-octahydronaphthalene; and a trimer or tetramer of cyclopentadiene such as 4,9:5,8-dimethano-3a,4,4a,5,8,8a,9,9a-octa hydro-1H-benzoindene, or 4,11:5,10:6,9-trimethano-3a,4,4a,5,5a,6,9,9a,10,10a,11,11a-dodecahydro-1H-cyclopentaanthracene. The above norbornene-based resin may be a copolymer of a norbornene-based monomer and another monomer.

As the above polycarbonate-based resin, an aromatic polycarbonate is preferably used. The aromatic polycarbonate can be typically obtained by the reaction between a carbonate precursor and an aromatic dihydric phenol compound. Specific examples of the carbonate precursor include phosgene, bischloroformate of dihydric phenols, diphenyl carbonate, di-p-tolylcarbonate, phenyl-p-tolylcarbonate, di-p-chlrophenylcarbonate, and dinaphthylcarbonate. Of those, phosgene and diphenylcarbonate are preferred. Specific examples of the aromatic dihydric phenol compound include: 2,2-bis(4-hydroxyphenyl)propane; 2,2-bis(4-hydroxy-3,5-dimethylphenyl)propane; bis(4-hydroxyphenyl)methane; 1,1-bis(4-hydroxyphenyl)ethane; 2,2-bis(4-hydroxyphenyl)butane; 2,2-bis(4-hydroxy-3,5-dimethylphenyl)butane; 2,2-bis(4-hydroxy-3,5-dipropylphenyl)propane; 1,1-bis(4-hydroxyphenyl)cyclohexane; and 1,1-bis(4-hydroxyphenyl)-3,3,5-trimethylcyclohexane. They may be used alone or in combination. Preferred are: 2,2-bis(4-hydroxyphenyl)propane; 1,1-bis(4-hydroxyphenyl)cyclohexane; and 1,1-bis(4-hydroxyphenyl)-3,3,5-trimethylcyclohexane. In particular, 2,2-bis(4-hydroxyphenyl)propane and 1,1-bis(4-hydroxyphenyl)-3,3,5-trimethylcyclohexane are preferably used in combination.

A-2-2. First Optical Compensation Layer (2)

In another embodiment, the first optical compensation layer 12 has a refractive index ellipsoid of nx>ny>nz. The in-plane retardation Re₁ of the first optical compensation layer is 80 to 300 nm, preferably 80 to 200 nm, more preferably 80 to 160 nm, and particularly preferably 100 to 140 nm. The first optical compensation layer can compensate for an optical axis of the polarizer. As described above, the first optical compensation layer is placed so that the slow axis thereof is perpendicular to the absorption axis of the polarizer, whereby a screen contrast when viewed from an oblique direction can be enhanced. Thus, it is one feature of the present invention that the first optical compensation layer is placed so that the slow axis thereof is perpendicular to the absorption axis of the polarizer. The Nz coefficient (Rth₁/Re₁) exhibits a relationship of preferably 1<Nz<2 and more preferably 1<Nz<1.5.

The first optical compensation layer having a refractive index ellipsoid of nx>ny>nz can be made of any suitable material. A specific example thereof includes a stretched polymer film. The resin forming the polymer film is preferably a norbornene-based resin or a polycarbonate-based resin. The detail of those resins is as described in Section A-2-1. As a method of producing a stretched film, any suitable method can be adopted. Examples of the stretching method include transverse uniaxial stretching, fixed-end biaxial stretching, and sequential biaxial stretching. A specific example of fixed-end biaxial stretching is a method of stretching a polymer film in a short side direction (transverse direction) while allowing the polymer film to run in a longitudinal direction. This method can be apparently transverse uniaxial stretching. The stretching temperature is preferably 135 to 165° C. and more preferably 140 to 160° C. The stretching ratio is preferably 1.2 to 3.2 times and more preferably 1.3 to 3.1 times. In this case, the thickness of the first optical compensation layer is typically 20 to 80 μm, preferably 25 to 75 μm, and more preferably 30 to 60 μm.

An other specific example of the material for forming the first optical compensation layer having a refractive index ellipsoid of nx>ny>nz includes a non-liquid crystalline material. The non-liquid crystalline material is preferably a non-liquid crystalline polymer. Specifically, polymers such as polyamide, polyimide, polyester, polyetherketone, polyamideimide, and polyesterimide are preferred. Those polymers may be used alone or as a mixture of two or more kinds thereof. Of those, polyimide is particularly preferred due to high transparency, high alignment property, and high stretchability.

The first optical compensation layer can be formed typically by applying a solution of the non-liquid crystalline polymer to a base film and removing a solvent. In the method of forming the first optical compensation layer, preferably, a treatment for giving optical biaxiality (nx>ny>nz) (e.g., a stretching treatment) is performed. Such a treatment can surely provide a refractive index difference (nx>ny) in a plane. Specific examples of the polyimide and specific examples of the method of forming the first optical compensation layer include polymers and a method of producing an optical compensation layer described in JP 2004-46065 A. In this case, the thickness of the first optical compensation layer is typically 0.1 to 10 μm, more preferably 0.1 to 8 μm, and particularly preferably 0.1 to 5 μm.

A-3. Second Optical Compensation Layer

The second optical compensation layer 13 has a refractive index ellipsoid of nz>nx=ny. The thickness direction retardation Rth₂ of the second optical compensation layer is preferably −50 to −300 nm, more preferably −70 to −250 nm, particularly preferably −90 to −200 nm, and most preferably −100 to −180 nm. Here, “nx=ny” includes not only the case where nx and ny are strictly equal to each other but also the case where nx and ny are substantially equal to each other. More specifically, the expression “nx=ny” refers to that Re₂ is less than 10 nm.

The second optical compensation layer can be made of any suitable material. Preferably, the second optical compensation layer is formed of a film containing a liquid crystal material fixed in a homeotropic alignment. A liquid crystal material (liquid crystal compound) that can be homeotropically aligned may be a liquid crystal monomer or a liquid crystal polymer. Specific examples of the liquid crystal compound and the method of forming the optical compensation layer include a liquid crystal compound and a method of forming a film described in paragraphs [0020] to [0042] of JP 2002-333642 A. In this case, the thickness of the second optical compensation layer is preferably 0.5 to 10 μm, more preferably 0.5 to 8 μm, and particularly preferably 0.5 to 5 μm.

A-4. Third Optical Compensation Layer

The third optical compensation layer has a refractive index ellipsoid of nx>ny=nz. Here, “ny=nz” includes not only the case where ny and nz are strictly equal to each other but also the case where ny and nz are substantially equal to each other. More specifically, the expression “ny=nz” refers to the case where an Nz coefficient (Rth₃/Re₃) is more than 0.9 and less than 1.1. The in-plane retardation Re₃ of the third optical compensation layer is 80 to 200 nm, preferably 100 to 200 nm, and particularly preferably 110 to 150 nm. More specifically, the third optical compensation layer can function as a λ/4 plate. The third optical compensation layer can convert, for example, linearly polarized light with a particular wavelength into circularly polarized light (or circularly polarized light into linearly polarized light) as a λ/4 plate.

The third optical compensation layer can be made of any suitable material. Specific examples thereof include the liquid crystal material described in Section A-2-1. In the case where the third optical compensation layer is made of the liquid crystal material, the thickness thereof is typically 0.5 to 10 μm, preferably 0.5 to 8 μm, and more preferably 0.5 to 5 μm. An other specific example is the stretched polymer film described in Section A-2-1. In the case where the third optical compensation layer is the stretched polymer film, the thickness thereof is typically 5 to 70 μm, preferably 10 to 65 μm, and more preferably 15 to 60 μm.

A-5. Fourth Optical Compensation Layer

The laminated optical film of the present invention can further include a fourth optical compensation layer, as described above. By providing the fourth optical compensation layer, a screen contrast can further be enhanced and a color shift can further be reduced. The fourth optical compensation layer 15 has a refractive index ellipsoid of nx=ny>nz. Here, “nx=ny” includes not only the case where nx and ny are strictly equal to each other but also the case where nx and ny are substantially equal to each other. More specifically, the expression “nx=ny” refers to that Re₄ is less than 10 nm. The thickness direction retardation Rth₄ of the fourth optical compensation layer can be set to be any suitable value depending upon the configuration of a liquid crystal panel to which the fourth optical compensation layer is applied. Although the detail thereof will be described in Section B-4 later, when the fourth optical compensation layer is placed on only one side of the liquid crystal cell, the thickness direction retardation Rth₄ is preferably 50 to 600 nm, more preferably 100 to 540 nm, and particularly preferably 150 to 500 nm. On the other hand, when the fourth optical compensation layers are placed on both sides of the liquid crystal cell, the thickness direction retardation Rth₄ is preferably 25 to 300 nm, more preferably 50 to 270 nm, and particularly preferably 75 to 250 nm.

The fourth optical compensation layer can be formed of any suitable material as long as the above properties can be obtained. A specific example of the fourth optical compensation layer includes a cholesteric alignment fixed layer. The term “cholesteric alignment fixed layer” refers to a layer in which constituent molecules of the layer have a helical structure, a helical axis thereof is aligned substantially perpendicularly with respect to a plane direction, and an alignment state thereof is fixed. Thus, the “cholesteric alignment fixed layer” includes not only the case where a liquid crystal compound exhibits a cholesteric liquid crystal phase, but also the case where a non-liquid crystal compound has a pseudo structure as in a cholesteric liquid crystal phase. For example, the “cholesteric alignment fixed layer” can be formed by allowing a liquid crystal material to be aligned in a cholesteric structure (helical structure) by providing the liquid crystal material with distortion, using a chiral agent in a state where the liquid crystal material exhibits a liquid crystal phase, and subjecting the liquid crystal material in this state to polymerization or cross-linking treatment, thereby fixing the alignment (cholesteric structure) of the liquid crystal material.

A specific example of the cholesteric alignment fixed layer includes a cholesteric layer described in JP 2003-287623 A.

The thickness of the fourth optical compensation layer can be set to be any suitable value as long as the desired optical characteristics described above can be obtained. In the case where the fourth optical compensation layer is a cholesteric alignment fixed layer, the thickness of the fourth optical compensation layer is preferably 0.5 to 10 μm, more preferably 0.5 to 8 μm, and particularly preferably 0.5 to 5 μm.

A specific example of the material forming the fourth optical compensation layer includes a non-liquid crystalline material. A non-liquid crystalline polymer is particularly preferred. Unlike the liquid crystalline material, such a non-liquid crystalline material can form a film exhibiting optical uniaxiality of nx=ny>nz due to the properties thereof, irrespective of the alignment property of a substrate. As the non-liquid crystalline material, for example, polymers such as polyamide, polyimide, polyester, polyetherketone, polyamideimide, and polyesterimide are preferred because of excellent heat resistance, chemical resistance, and transparency, and superior rigidity. Any one kind of those polymers may be used alone, or may be used as a mixture of two or more kinds thereof having different functional groups, such as a mixture of polyaryl ether ketone and polyamide. Of those polymers, polyimide is particularly preferred because of high transparency, high alignment property, and high stretchability.

As a specific example of the polyimide and a specific example of a method of forming the fourth optical compensation layer, there are the polymers and the method of producing an optical compensation film described in JP 2004-46065 A.

The thickness of the fourth optical compensation layer can be set to be any suitable value as long as the desired optical characteristics described above can be obtained. In the case where the fourth optical compensation layer is formed of a non-liquid crystalline material, the thickness of the fourth optical compensation layer is preferably 0.5 to 10 μm, more preferably 0.5 to 8 μm, and particularly preferably 0.5 to 5 μm.

Other specific examples of the material forming the fourth optical compensation layer include polymer films formed of a cellulose-based resin such as triacetylcellulose (TAC), norbornene-based resin, and the like. As the fourth optical compensation layer, a commercially available film can be used as it is. Further, a film obtained by subjecting a commercially available film to a secondary treatment such as a stretching and/or shrinkage treatment can be used. Examples of the commercially available film include Fujitac series (ZRF80S, TD80UF, TDY-80UL (trade name)) manufactured by Fuji Photo Film Co., Ltd., “KC8UX2M” (trade name) manufactured by Konica Minolta Opt Product, “Zeonor” (trade name) manufactured by Zeon Corporation, and “Arton” (trade name) manufactured by JSR Corporation. Norbornene-based monomers constituting a norbornene-based resin are as described above in Section A-2-1. As a stretching method capable of satisfying the optical characteristics, there is, for example, given biaxial stretching (vertical and transverse equal magnification stretching).

The thickness of the fourth optical compensation layer can be set to be any suitable value as long as the desired optical characteristics described above can be obtained. In the case where the fourth optical compensation layer is a polymer film formed of a cellulose-based resin, a norbornene-based resin, or the like, the thickness of the fourth optical compensation layer is preferably 45 to 105 μm, more preferably 50 to 95 μm, and particularly preferably 55 to 90 μm.

Still another specific example of the fourth optical compensation layer is a laminate having the cholesteric alignment fixed layer and a plastic film layer. Examples of a resin forming the plastic film layer include a cellulose-based resin and a norbornene-based resin. Those resins are as described above.

As a method of laminating the cholesteric alignment fixed layer and the plastic film layer, any suitable method can be adopted. Specifically, there are a method of transferring the cholesteric alignment fixed layer onto the plastic layer, a method of attaching the cholesteric alignment fixed layer previously formed on a base to the plastic film layer via an adhesive layer, and the like. The thickness of the adhesive layer is preferably 1 μm to 10 μm, and more preferably 1 μm to 5 μm.

A-6. Polarizer

Any appropriate polarizer may be employed as the above-mentioned polarizer 11 in accordance with a purpose. Examples thereof include: a film prepared by adsorbing a dichromatic substance such as iodine or a dichromatic dye on a hydrophilic polymer film such as a polyvinyl alcohol-based film, a partially formalized polyvinyl alcohol-based film, or a partially saponified ethylene/vinyl acetate copolymer-based film and uniaxially stretching the film; and a polyene-based aligned film such as a dehydrated product of a polyvinyl alcohol-based film or a dechlorinated product of a polyvinyl chloride-based film. Of those, a polarizer prepared by adsorbing a dichromatic substance such as iodine on a polyvinyl alcohol-based film and uniaxially stretching the film is particularly preferable because of high polarized dichromaticity. A thickness of the polarizer is not particularly limited, but is generally about 1 to 80 μm.

The polarizer prepared by adsorbing iodine on a polyvinyl alcohol-based film and uniaxially stretching the film may be produced by, for example: immersing a polyvinyl alcohol-based film in an aqueous solution of iodine for coloring; and stretching the film to a 3 to 7 times the length of the original length. The aqueous solution may contain boric acid, zinc sulfate, zinc chloride, or the like as required, or the polyvinyl alcohol-based film may be immersed in an aqueous solution of potassium iodide or the like. Further, the polyvinyl alcohol-based film may be immersed and washed in water before coloring as required.

Washing the polyvinyl alcohol-based film with water not only allows removal of contamination on a film surface or washes away an antiblocking agent, but also provides an effect of preventing nonuniformity such as uneven coloring by swelling of the polyvinyl alcohol-based film. The stretching of the film may be performed after coloring of the film with iodine, performed during coloring of the film, or performed followed by coloring of the film with iodine. The stretching may be performed in an aqueous solution of boric acid or potassium iodide or in a water bath.

A-7. Protective Layer

The first protective layer and the second protective layer are formed of any appropriate film which can be used as a protective film of a polarizing plate. Specific examples of a material used as a main component of the film include transparent resins such as a cellulose-based resin such as triacetylcellulose (TAC), a polyester-based resin, a polyvinyl alcohol-based resin, a polycarbonate-based resin, a polyamide-based resin, a polyimide-based resin, a polyether sulfone-based resin, a polysulfone-based resin, a polystyrene-based resin, a polynorbornene-based resin, a polyolefin-based resin, a (meth)acrylic resin, and an acetate-based resin. An other example thereof includes a thermosetting resin or a UV-curing resin such as a (meth)acrylic-based resin, an urethane-based resin, a (meth)acrylic urethane-based resin, an epoxy-based resin, or a silicone-based resin. Still another example thereof includes, for example, a glassy polymer such as a siloxane-based polymer. Further, a polymer film described in JP 2001-343529 A (WO 01/37007) may also be used. To be specific, the film can be formed of a resin composition containing a thermoplastic resin having a substituted or unsubstituted imide group on a side chain and a thermoplastic resin having a substituted or unsubstituted phenyl group and a nitrile group on a side chain. A specific example thereof includes a resin composition containing an alternate copolymer of isobutene and N-methylmaleimide and an acrylonitrile-styrene copolymer. The polymer film may be an extruded product of the resin composition, for example.

Glass transition temperature (Tg) of the (meth)acrylic resin is preferably 115° C. or higher, more preferably 120° C. or higher, still more preferably 125° C. or higher, and particularly preferably 130° C. or higher. This is because the (meth)acrylic resin having a glass transition temperature (Tg) of 115° C. or higher can be excellent in durability. The upper limit value of Tg of the (meth)acrylic resin is not particularly limited, but is preferably 170° C. or lower from the viewpoint of formability and the like.

As the (meth)acrylic resin, any appropriate (meth)acrylic resin can be adopted as long as the effects of the present invention are not impaired. Examples of the (meth)acrylic resin include poly (meth)acrylates such as methyl polymethacrylate, a methyl methacrylate-(meth)acrylic acid copolymer, a methyl methacrylate-(meth)acrylate copolymer, a methyl methacrylate-acrylate-(meth)acrylic acid copolymer, a methyl (meth)acrylate-styrene copolymer (MS resin, etc.), and a polymer having an alicyclic hydrocarbon group (e.g., a methyl metharylate-cyclohexyl methacrylate copolymer, a methyl methacrylate-norbornyl (meth)acrylate copolymer). A preferred example includes C₁₋₆ alkyl poly(meth)acrylate such as polymethyl (meth)acrylate. A more preferred example includes a methyl methacrylate-based resin containing methyl methacrylate as a main component (50 to 100% by weight, preferably 70 to 100% by weight).

Specific examples of the (meth)acrylic resin include ACRYPET VH and ACRYPET VRL20A manufactured by Mitsubishi Rayon Co., Ltd., a (meth)acrylic resin having a ring structure in molecules described in JP 2004-70296 A, and a (meth)acrylic resin with high Tg obtained by intramolecular cross-linking or intramolecular cyclization reaction.

As the above (meth)acrylic resin, a (meth)acrylic resin having a lactone ring structure is particularly preferred because of high heat resistance, high transparency, and high mechanical strength.

Examples of the (meth)acrylic resin having the lactone ring structure include (meth)acrylic resins having a lactone ring structure described in JP 2000-230016 A, JP 2001-151814 A, JP 2002-120326 A, JP 2002-254544 A, and JP 2005-146084 A.

The mass average molecular weight (which may also be referred to as weight average molecular weight) of the (meth)acrylic resin having a lactone ring structure is preferably 1,000 to 2,000,000, more preferably 5,000 to 1,000,000, much more preferably 10,000 to 500,000, and particularly preferably 50,000 to 500,000.

The glass transition temperature (Tg) of the (meth)acrylic resin having the lactone ring structure is preferably 115° C. or higher, more preferably 125° C. or higher, still more preferably 130° C. or higher, particularly preferably 135° C. or higher, and most preferably 140° C. or higher. This is because the (meth)acrylic resin having a lactone ring structure and having Tg of 115° C. or higher can be excellent in durability. The upper limit value of the Tg of the (meth)acrylic resin having a lactone ring structure is not particularly limited, but is preferably 170° C. or lower from the viewpoint of formability and the like.

In this specification, the term “(meth)acrylic” refers to acrylic and/or methacrylic.

The first protective layer and the second protective layer are preferably transparent and color less. The thickness direction retardation (Rth) of the second protective layer is preferably −90 nm to +90 nm, more preferably −80 nm to +80 nm, and much more preferably −70 nm to +70 nm.

As the thickness of the first protective layer and the second protective layer, any suitable thickness can be adopted as long as the above preferred thickness direction retardation Rth can be obtained. The thickness of the second protective layer is typically 5 mm or less, preferably 1 mm or less, more preferably 1 to 500 μm, and much more preferably 5 to 150 μm.

The side of the second protective layer opposite to the polarizer can be subjected to hard coat treatment, antireflection treatment, sticking prevention treatment, antiglare treatment, or the like, if required.

The thickness direction retardation (Rth) of the first protective layer provided between the polarizer and the optical compensation layer is preferably smaller than the above preferred value. As described above, in the case of a cellulose-based film generally used as a protective film, e.g., a triacetylcellulose film, the thickness direction retardation (Rth) is about 60 nm at a thickness of 80 μm. A cellulose-based film with large thickness direction retardation (Rth) can be subjected to appropriate treatment for decreasing the thickness direction retardation (Rth), thereby the first protective layer can be obtained in a preferred manner.

As treatment for decreasing the above thickness direction retardation (Rth), any suitable treatment method can be adopted. Examples thereof include a method of attaching a base made of polyethylene terephthalate, polypropylene, stainless steel or the like with a solvent such as cyclopentanone or methylethylketone applied thereto to a general cellulose-based film, drying the laminate by heating (for example, for about 3 to 10 minutes at about 80 to 150° C.), and thereafter peeling the base; and a method of applying a solution in which a norbornene-based resin, an acrylic resin, or the like is dissolved in a solvent such as cyclopentanone or methylethylketone to a general cellulose-based film, dying the laminate by heating (for example, for about 3 to 10 minutes at 80 to 150° C.), and thereafter peeling the applied film.

Examples of materials forming the above cellulose-based film preferably include aliphatic acid-substituted cellulose-based polymers such as diacetylcellulose and triacetylcellulose. Although the acetic acid substitution degree in generally used triacetylcellulose is about 2.8, the thickness direction retardation (Rth) can be controlled to be small preferably by controlling the acetic acid substitution degree to 1.8 to 2.7, and more preferably by controlling the propionic acid substitution degree to 0.1 to 1.

By adding a plasticizer such as dibutylphthalate, p-toluenesulfonanilide, or acetyltriethyl citrate to the above aliphatic acid-substituted cellulose-based polymer, the thickness direction retardation (Rth) can be controlled to be small. The adding amount of the plasticizer is preferably 40 parts by weight or less, more preferably 1 to 20 parts by weight, and much more preferably 1 to 15 parts by weight with respect to 100 parts by weight of the aliphatic acid-substituted cellulose-based polymer.

The treatment methods of decreasing the above thickness direction retardation (Rth) may be used in an appropriate combination. The thickness direction retardation Rth (550) of the first protective layer obtained by the treatment is preferably −20 nm to +20 nm, more preferably −10 nm to +10 nm, much more preferably −6 nm to +6 nm, and particularly preferably −3 nm to +3 nm. The in-plane retardation Re(550) of the first protective layer is preferably 0 nm or more and 10 nm or less, more preferably 0 nm or more and 6 nm or less, and much more preferably 0 nm or more and 3 nm or less.

The thickness of the first protective layer is preferably 20 to 200 μm, more preferably 30 to 100 μm, and much more preferably 35 to 95 μm.

A-8. Lamination Method

As the method of laminating each layer (film), any suitable method can be adopted. Specifically, each layer is laminated via any suitable pressure-sensitive adhesive layer or adhesive layer. A typical example of the pressure-sensitive adhesive layer includes an acrylic pressure-sensitive adhesive layer. The thickness of the acrylic pressure-sensitive adhesive layer is preferably 1 to 30 μm and more preferably 3 to 25 μm.

As described above, in the case where the first optical compensation layer 12 functions as a protective layer of the polarizer 11, the polarizer and the first optical compensation layer are laminated via any suitable adhesive layer. As described above, in the case of producing a first optical compensation layer having a refractive index ellipsoid of nx>ny>nz by fixed-end biaxial stretching, a slow axis can be generated in a short side direction. On the other hand, an absorption axis direction of the polarizer can be generated in a stretching direction (longitudinal direction). Thus, in the case where the first optical compensation layer and the polarizer are placed so that the slow axis of the first optical compensation layer is perpendicular to the absorption axis of the polarizer as in the present invention, the first optical compensation layer and the polarizer can be laminated continuously by roll-to-roll. Examples of the adhesive used for lamination of the polarizer and the first optical compensation layer include adhesives containing a polyvinyl alcohol-based resin, a cross-linking agent, and a metal compound colloid.

Examples of the above polyvinyl alcohol-based resin include a polyvinyl alcohol resin and a polyvinyl alcohol resin containing an acetoacetyl group. The polyvinyl alcohol resin containing an acetoacetyl group is preferred since durability can be enhanced.

Examples of the above-mentioned polyvinyl alcohol-based resin include: a saponified polyvinyl acetate and derivatives of the saponified product; a saponified product of a copolymer obtained by copolymerizing vinyl acetate with a monomer having copolymerizability; and a modified polyvinyl alcohol obtained by modifying polyvinyl alcohol to acetal, urethane, ether, graft, or phosphate. Examples of the monomer include unsaturated carboxylic acids such as maleic acid (anhydrides), fumaric acid, crotonic acid, itaconic acid, and (meth)acrylic acid and esters thereof; α-olefin such as ethylene and propylene; (sodium) (meth) allylsulfonate; sodium sulfonate (monoalkylmalate); sodium disulfonate alkylmalate; N-methylol acrylamide; alkali salts of acrylamide alkylsulfonate; N-vinylpyrrolidone; and derivatives of N-vinylpyrrolidone. Those resins may be used alone or in combination.

The polyvinyl alcohol-based resin has an average degree of polymerization of preferably about 100 to 5,000, and more preferably 1,000 to 4,000, from a viewpoint of adhesion property. The polyvinyl alcohol-based resin has an average degree of saponification of preferably about 85 to 100 mol %, and more preferably 90 to 100 mol %, from a viewpoint of adhesion property.

The above polyvinyl alcohol-based resin containing an acetoacetyl group is obtained, for example, by reacting a polyvinyl alcohol-based resin with diketene by any method. Specific examples thereof include a method of adding diketene to a dispersion in which a polyvinyl alcohol-based resin is dispersed in a solvent such as acetic acid, a method of adding diketene to a solution in which a polyvinyl alcohol-based resin is dissolved in a solvent such as dimethylformamide or dioxane, and a method of bringing diketene gas or liquid diketene into direct contact with a polyvinyl alcohol-based resin.

The acetoactyl group modification degree of the above polyvinyl alcohol-based resin containing an acetoacetyl group is typically 0.1 mol % or more, preferably about 0.1 to 40 mol %, more preferably 1 to 20 mol %, and particularly preferably 2 to 7 mol %. When the modification degree is less than 0.1 mol %, water resistance may be insufficient. When the modification degree exceeds 40 mol %, the effect of the enhancement of water resistance is small. The acetoacetyl group modification degree is a value measured by NMR.

As the cross-linking agent, any appropriate cross-linking agent may be employed. Preferably, a compound having at least two functional groups each having reactivity with a polyvinyl alcohol-based resin can be used as a cross-linking agent. Examples of the compound include: alkylene diamines having an alkylene group and two amino groups such as ethylene diamine, triethylene diamine, and hexamethylenediamine; isocyanates such as tolylenediisocyanate, hydrogenated tolylene diisocyanate, trimethylol propane tolylene diisocyanate adduct, triphenylmethane triisocyanate, methylene bis(4-phenylmethane)triisocyanate, isophorone diisocyanate, and ketoxime blocked compounds thereof or phenol blocked compounds thereof; epoxides such as ethylene glycol diglycidyl ether, polyethylene glycol diglycidyl ether, glycerin di- or triglycidyl ether, 1,6-hexane diol diglycidyl ether, trimethylol propane triglycidyl ether, diglycidyl aniline, and diglycidyl amine; monoaldehydes such as formaldehyde, acetaldehyde, propione aldehyde, and butyl aldehyde; dialdehydes such as glyoxal, malondialdehyde, succinedialdehyde, glutardialdehyde, maleic dialdehyde, and phthaldialdehyde; an amino-formaldehyde resin such as a condensate of formaldehyde with methylolurea, methylolmelamine, alkylated methylolurea, alkylated methylol melamine, acetoguanamine, or benzoguanamine; and salts of sodium, potassium, divalent metals or trivalent metals such as magnesium, calcium, aluminum, iron, and nickel and oxides thereof. Of those, an amino-formaldehyde resin and dialdehydes are preferred. As the amino-formaldehyde resin, a compound having a methylol group is preferred, and as the dialdehydes, glyoxal is preferred. Of those, a compound having a methylol group is preferred, and methylol melamine is particularly preferred.

The blending amount of the above cross-linking agent can be appropriately set depending upon the kind of the above polyvinyl alcohol-based resin and the like. Typically, the blending amount of the above cross-linking agent is about 10 to 60 parts by weight, and preferably 20 to 50 parts by weight based on 100 parts by weight of the polyvinyl alcohol-based resin. This is because the cross-linking agent in such a blending amount can contribute to an excellent adhesion. In the case where the blending amount of the cross-linking agent is large, the reaction of the cross-linking agent proceeds in a short period of time, and an adhesive tends to be gelled. Consequently, the usable time (pot life) of the adhesive becomes extremely short, which may make it difficult to use the adhesive industrially. The adhesive of the present embodiment contains a metal compound colloid described later, so the adhesive can be used with good stability even in the case where the blending amount of the cross-linking agent is large.

The above metal compound colloid can have a configuration in which metal compound fine particles are dispersed in a dispersion medium, and can be electrostatically stabilized due to the interaction between the same charges of the fine particles to have stability perpetually. The average particle diameter of the fine particles forming a metal compound colloid can be any suitable value as long as the optical properties such as polarization properties are not adversely influenced. The average particle diameter is preferably 1 to 100 nm, and more preferably 1 to 50 nm. This is because the fine particles can be dispersed uniformly in an adhesive layer to keep adhesion, and the occurrence of knick can be suppressed. The term “knick” refers to local uneven defects formed at an interface between a polarizer and a protective layer.

As the above metal compound, any suitable compound can be adopted. Examples of the metal compound include a metal oxide such as alumina, silica, zirconia, or titania; a metal salt such as aluminum silicate, calcium carbonate, magnesium silicate, zinc carbonate, barium carbonate, or calcium phosphate; and a mineral such as cerite, talc, clay, or kaolin. Among them, alumina is preferred.

The metal compound colloid is typically present in a state of a colloid solution in which the metal compound colloid is dispersed in a dispersion medium. Examples of the dispersion medium include water and alcohols. The concentration of a solid content in a colloid solution is typically about 1 to 50% by weight. The colloid solution can contain acids such as nitric acid, hydrochloric acid, and acetic acid as a stabilizer.

The blending amount of the above metal compound colloid (solid content) is preferably 200 parts by weight or less, more preferably 10 to 200 parts by weight, much more preferably 20 to 175 parts by weight, and most preferably 30 to 150 parts by weight based on 100 parts by weight of the polyvinyl alcohol-based resin. This is because such a blending amount can suppress the occurrence of knick while keeping adhesion.

The adhesive of the present embodiment can contain: a coupling agent such as a silane coupling agent and a titanium coupling agent; various kinds of tackifiers; a UV absorber; an antioxidant; and stabilizers such as a heat-resistant stabilizer and a hydrolysis-resistant stabilizer.

The form of the adhesive of the present embodiment is preferably an aqueous solution (resin solution). The resin concentration is preferably 0.1 to 15% by weight and more preferably 0.5 to 10% by weight in view of application property, storage stability, and the like. The viscosity of the resin solution is preferably 1 to 50 mPa·s. The pH of the resin solution is preferably 2 to 6, more preferably 2.5 to 5, much more preferably 3 to 5, and most preferably 3.5 to 4.5. Generally, the surface charge of the metal compound colloid can be controlled by adjusting the pH. The surface charge is preferably a positive charge. Due to the presence of a positive charge, for example, the occurrence of knick can be suppressed.

As a method of preparing the above resin solution, any suitable method can be adopted. For example, there is a method of previously mixing a polyvinyl alcohol-based resin with a cross-linking agent and adjusting the mixture to an appropriate concentration, and blending a metal compound colloid with the resultant mixture. Alternatively, after a polyvinyl alcohol-based resin is mixed with a metal compound colloid, a cross-linking agent can be mixed with the mixture considering a use time and the like. The concentration of the resin solution may be adjusted after preparation of a resin solution.

B. Liquid Crystal Panel

B-1. Whole Configuration of Liquid Crystal Panel

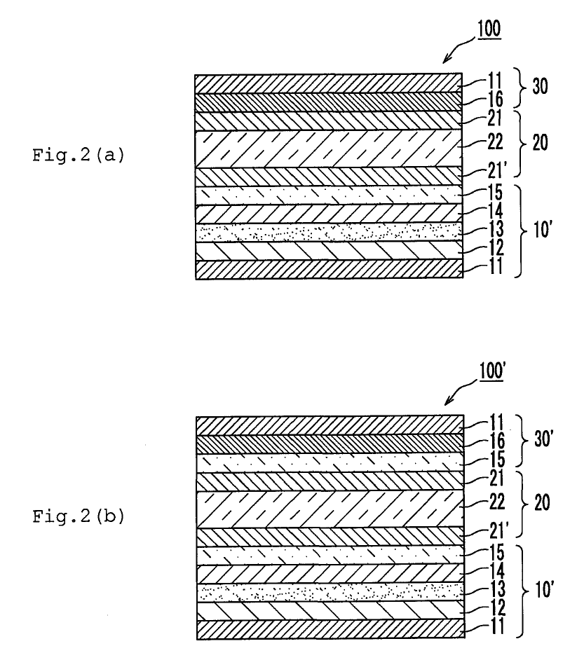

FIG. 2(a) is a schematic cross-sectional view of a liquid crystal panel according to one embodiment of the present invention. A liquid crystal panel 100 includes a liquid crystal cell 20, a laminated optical film 10′ of the present invention placed on one side (backlight side in the illustrated example) of the liquid crystal cell 20, and a laminated film 30 placed on the other side (viewer side in the illustrated example) of the liquid crystal cell 20. The laminated film 30 includes the polarizer 11 and a fifth optical compensation layer 16. In the present embodiment, the fifth optical compensation layer 16 has a refractive index ellipsoid exhibiting a relationship of nx>ny=nz and an in-plane retardation Re₅ of 80 to 200 nm. The laminated film 30 includes, if required, a first protective layer between the polarizer 11 and the fifth optical compensation layer 16, and a second protective layer on a side of the polarizer 11 opposite to the fifth optical compensation layer 16. Further, although not shown, the laminated film 30 can further include any suitable another optical compensation layer. As shown, the laminated optical film 10′ and the laminated film 30 are placed so that sides on which the optical compensation layers are provided are placed on the liquid crystal cell 20 side.

FIG. 2(b) is a schematic cross-sectional view of a liquid crystal panel according to another embodiment of the present invention. A liquid crystal panel 100′ includes a liquid crystal cell 20, a laminated optical film 10′ of the present invention placed on one side (backlight side in the illustrated example) of the liquid crystal cell 20, and a laminated film 30′ placed on the other side (viewer side in the illustrated example) of the liquid crystal cell 20. The laminated film 30′ includes the polarizer 11, the fifth optical compensation layer 16, and the fourth optical compensation layer 15. In the laminated film 30′, if required, a first protective layer is provided between the polarizer 11 and the fifth optical compensation layer 16, and a second protective layer is provided on the side of the polarizer 11 opposite to the fifth optical compensation layer 16. Further, although not shown, the laminated film 30′ may further include any suitable another optical compensation layer. As shown, the laminated optical film 10′ and the laminated film 30′ are placed so that the sides on which the optical compensation layers are provided are placed on the liquid crystal cell 20 side.

Unlike the illustrated example, the laminated optical film 10 may be placed instead of the laminated optical film 10′. Further, unlike the illustrated example, the laminated optical film 10′ (10) may be placed on the viewer side, and the laminated films 30, 30′ may be placed on the backlight side. Preferably, the laminated optical film 10′ (10) is placed on the backlight side as in the illustrated example.

The fifth optical compensation layer 16 constituting the laminated films 30, 30′ is laminated on the polarizer 11 constituting the laminated films 30, 30′ so that the slow axis of the fifth optical compensation layer 16 defines any suitable angle with respect to the absorption axis of the polarizer 11. The angle to be defined is preferably 30 to 60°, more preferably 35 to 55°, particularly preferably 40 to 50°, and most preferably 43 to 47°.

It is preferred that the polarizers 11, 11 placed on both sides of the liquid crystal cell 20 of the liquid crystal panels 100, 100′ are placed so that the absorption axes of the polarizers 11, 11 are substantially perpendicular to each other.

B-2. Liquid Crystal Cell The liquid crystal cell 20 is provided with a pair of substrates 21, 21′ and a liquid crystal layer 22 as a display medium held between the substrates 21, 21′. One substrate 21 (color filter substrate) is provided with color filters and black matrix (both not shown). The other substrate 21′ (active matrix substrate) is provided with: a switching element (typically TFT) (not shown) for controlling electrooptic properties of liquid crystals; a scanning line (not shown) for providing a gate signal to the switching element and a signal line (not shown) for providing a source signal thereto; and a pixel electrode (not shown). Note that the color filters may be provided in the active matrix substrate 21′ side. A distance (cell gap) between the substrates 21, 21′ is controlled by a spacer (not shown). An aligned film (not shown) formed of, for example, polyimide is provided on a side of each of the substrates 21, 21′, which is in contact with the liquid crystal layer 22.

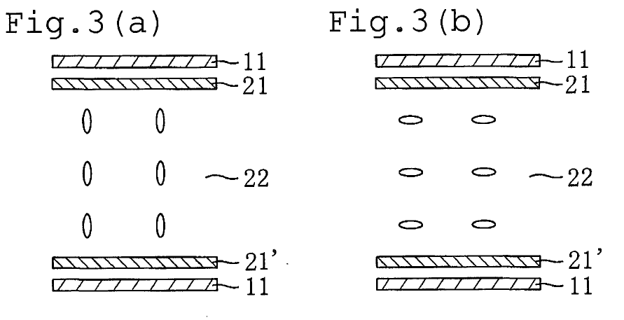

As a drive mode of the liquid crystal cell 20, any suitable drive modes may be employed. The drive mode is preferably a VA mode. FIG. 3 is a schematic cross-sectional view illustrating an alignment state of liquid crystal molecules in a VA mode. As shown in FIG. 3(a), liquid crystal molecules are aligned vertically to the substrates 21, 21′ without application of a voltage. Such vertical alignment is realized by arranging nematic liquid crystal having negative dielectric anisotropy between the substrates each having a vertical alignment film formed thereon (not shown). When light enters from a surface of one substrate 21 in such a state, linear polarized light incident upon the liquid crystal layer 22 through one polarizer 11 advances along a longitudinal direction of the vertically aligned liquid crystal molecules. No birefringence occurs in the longitudinal direction of the liquid crystal molecules, and thus the incident light advances without changing a polarization direction and is absorbed by the other polarizer 11 having an absorption axis perpendicular to the one polarizer 11. In this way, a dark state is displayed without application of a voltage (normally black mode). As shown in FIG. 3(b), longitudinal axes of the liquid crystal molecules are aligned parallel to the substrate surfaces when a voltage is applied between the electrodes. The liquid crystal molecules in such a state exhibit birefringence with respect to linear polarized light incident upon the liquid crystal layer 22 through the one polarizer 11, and a polarization state of the incident light changes in accordance with inclination of the liquid crystal molecules. Light passing through the liquid crystal layer during application of a predetermined maximum voltage is converted into linear polarized light having a polarization direction rotated by 90°, for example. Thus, the light passes through the other polarizer 11, and a bright state is displayed. Upon termination of voltage application, the display is returned to a dark state by an alignment restraining force. An applied voltage is changed to control inclination of the liquid crystal molecules, so as to change an intensity of light transmission from the other polarizer 11. As a result, display of gradation can be realized.

B-3. Fifth Optical Compensation Layer

The fifth optical compensation layer 16 preferably has a refractive index ellipsoid exhibiting a relationship of nx>ny=nz and an in-plane retardation Re₅ of 80 to 200 nm. More specifically, the fifth optical compensation layer 16 can function as a λ/4 plate. As the fifth optical compensation layer, a layer similar to the third optical compensation layer can be adopted.

B-4. Regarding Thickness Direction Retardation of Fourth Optical Compensation Layer

As shown in FIG. 2(a), in the case where the fourth optical compensation layer 15 is placed only on one side of the liquid crystal cell 20, the thickness direction retardation Rth₄ of the fourth optical compensation layer is preferably 50 to 600 nm, more preferably 100 to 540 nm, and particularly preferably 150 to 500 nm. On the other hand, as shown in FIG. 2(b), in the case where the fourth optical compensation layer 15 is placed on both sides of the liquid crystal cell 20, the thickness direction retardation Rth₄ of each fourth optical compensation layer is preferably substantially a half of the thickness direction retardation in the case where the fourth optical compensation layer 15 is placed on one side. More specifically, the thickness direction retardation Rth₄ is preferably 25 to 300 nm, more preferably 50 to 270 nm, and particularly preferably 75 to 250 nm.

B-5. Lamination Method

As the lamination method of each layer (film), any suitable method can be adopted. Specifically, each layer is laminated via any suitable pressure-sensitive adhesive layer or adhesive layer.

### EXAMPLES

Hereinafter, the present invention is described specifically by way of examples. However, the present invention is not limited to those examples. The measurement methods of the respective properties are as follows.

(1) Measurement of Retardation Value

A retardation value was automatically measured using KOBRA-WPR manufactured by Oji Scientific Instruments. The measurement wavelength was 590 nm or 550 nm, and the measurement temperature was 23° C.

(2) Measurement 1 of Contrast Using actually measured optical property parameters of each actually produced optical compensation layer, a computer simulation was conducted with respect to the liquid crystal panels in the respective examples and comparative examples. For the simulation, a simulator for a liquid crystal display unit “LCD MASTER” manufactured by Shintech Inc. was used.

(3) Measurement 2 of Contrast

A white image and a black image were displayed on a liquid crystal display apparatus and measured by “EZ Contrast 160D” (trade name) manufactured by ELDIM Inc.

### Example 1

### Production of Polarizing Plate

A polyvinyl alcohol film was dyed in an aqueous solution containing iodine, and thereafter, the resultant film was uniaxially stretched by 6 times between rolls having different speed ratios in an aqueous solution containing boric acid to obtain a polarizer. Triacetylcellulose films (thickness: 40 μm, KC4UYW (trade name) manufactured by Konica Minola Holdings Inc.) were attached as protective layers (first protective layer and second protective layer) on both sides of the polarizer via a polyvinyl alcohol-based adhesive (thickness: 0.1 μm). The in-plane retardation Re (550) of the protective layers was 0.9 nm and the thickness direction retardation Rth (550) thereof was 1.2 nm. Thus, a polarizing plate was produced. Note that Re(550) shows a value measured with light having a wavelength of 550 nm at 23° C.

(Production of First Optical Compensation Layer)

A long norbornene-based resin film (Zeonor (trade name) manufactured by Zeon Corporation, thickness: 40 μm, photoelastic coefficient: 3.10×10⁻¹² m²/N) was subjected to uniaxial stretching by 1.52 times at 140° C., whereby a long film was produced. The thickness of the obtained film was 35 μm, the in-plane retardation Re₁ thereof was 140 nm, and the thickness direction retardation Rth₁ thereof was 140 nm. The obtained film was punched to a size corresponding to a liquid crystal cell described later to obtain a first optical compensation layer.

(Production of Second Optical Compensation Layer)

20 parts by weight of a side-chain type liquid crystal polymer represented by the following Chemical Formula (1) (numbers 65 and 35 in the formula represent mol % of a monomer unit, and the polymer is represented as a block polymer for convenience: weight average molecular weight 5,000), 80 parts by weight of a polymerizable liquid crystal (Paliocolor LC242 (trade name) manufactured by BASF SE) exhibiting a nematic liquid crystal phase, and 5 parts by weight of a photopolymerization initiator (Irgacure 907 (trade name) manufactured by Ciba Specialty Chemicals Inc.) were dissolved in 200 parts by weight of cyclopentanone to prepare a liquid crystal-application liquid. Then, the application liquid was applied to a base film (a norbornene-based resin film: Zeonor (trade name) manufactured Zeon Corporation) with a bar coater, and then, dried by heating at 80° C. for 4 minutes, whereby liquid crystal was aligned. The liquid crystal layer was cured by irradiation with UV-light, whereby a liquid crystal fixed layer to be a second optical compensation layer was formed on the base. The in-plane retardation of the layer was substantially zero, and the thickness direction retardation Rth₂ thereof was −120 nm.

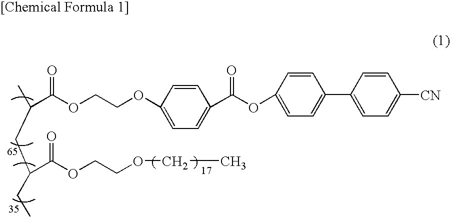

(Production of Third Optical Compensation Layer)

The same film as the first optical compensation layer was used.

(Production of Fourth Optical Compensation Layer)

90 parts by weight of the nematic liquid crystalline compound represented by the following Chemical Formula (2), 10 parts by weight of the chiral agent represented by the following Chemical Formula (3), 5 parts by weight of a photopolymerization initiator (Irgacure 907 manufactured by Ciba Specialty Chemicals Inc.), and 300 parts by weight of methyl ethyl ketone were mixed so as to be uniform, whereby a liquid crystal-application liquid was prepared. Next, the liquid crystal-application liquid was applied to a substrate (biaxially stretched PET film), heat-treated at 80° C. for 3 minutes, and polymerized by irradiation with UV-light, whereby a cholesteric alignment fixed layer to be a fourth optical compensation layer was formed on the substrate. The thickness of the cholesteric alignment fixed layer was 3 μm, the thickness direction retardation Rth₄ was 120 nm, and the in-plane retardation Re₄ was substantially zero.

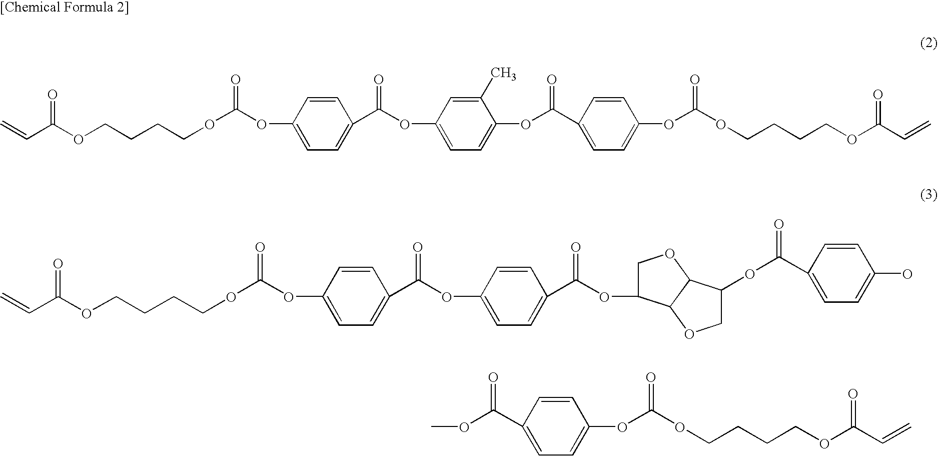

(Production of Fifth Optical Compensation Layer)

The same film as the first optical compensation layer was used.

(Production of Laminated Film A)

The cholesteric alignment fixed layer to be a fourth optical compensation layer was attached to the fifth optical compensation layer with an isocyanate-based adhesive (thickness: 5 μm), and the substrate (biaxially stretched PET film) was removed, whereby a laminate in which the cholesteric alignment fixed layer was transferred to the fifth optical compensation layer was obtained. The polarizing plate obtained above was laminated on the fifth optical compensation layer side of the laminate via an acrylic pressure-sensitive adhesive (thickness: 12 μm). At this time, the plate was laminated so that the slow axis of the fifth optical compensation layer was 45° in a clockwise direction with respect to the absorption axis of the polarizer of the polarizing plate, whereby a laminated film A was obtained.

(Production of Laminated Optical Film B)

The liquid crystal fixed layer to be a second optical compensation layer was attached to the first optical compensation layer with an isocyanate-based adhesive (thickness: 5 μm), and the base (norbornene-based rein film) was removed, whereby a laminate 1 in which the second optical compensation layer was transferred to the first optical compensation layer was obtained.

The cholesteric alignment fixed layer to be a fourth optical compensation layer was attached to the third optical compensation layer with an isocyanate-based adhesive (thickness: 5 μm), and the substrate (biaxially stretched PET film) was removed, whereby a laminate 2 in which the cholesteric alignment fixed layer was transferred to the third optical compensation layer was obtained.

The laminate 1 and the polarizing plate were laminated in this order on the third optical compensation layer side of the laminate 2 via an acrylic pressure-sensitive adhesive (thickness: 12 μm). At this time, the laminate 1 and the polarizing plate were laminated so that the first optical compensation layer of the laminate 1 was placed on the polarizing plate side. Further, they were laminated so that the slow axes of the first optical compensation layer and the third optical compensation layer were 900 and 450 in a clockwise direction with respect to the absorption axis of the polarizer of the polarizing plate, respectively. Thus, a laminated optical film B was produced.

(Production of Liquid Crystal Panel)

A liquid crystal cell was removed from a Playstation Portable (with a liquid crystal cell in a VA mode mounted thereon) manufactured by Sony Corporation, and the laminated film A was attached to the viewer side of the liquid crystal cell via an acrylic pressure-sensitive adhesive (thickness: 20 μm). At this time, the laminated film A was attached so that the fourth optical compensation layer was placed on the liquid crystal cell side. Further, the laminated optical film B was attached to the backlight side of the liquid crystal cell via an acrylic pressure-sensitive adhesive (thickness: 20 μm). At this time, the laminated optical film B was attached so that the fourth optical compensation layer was placed on the liquid crystal cell side. Further, the laminated optical film B was laminated so that the absorption axis of the polarizer of the laminated film A was substantially perpendicular to the absorption axis of the polarizer of the laminated optical film B. Thus, a liquid crystal panel was produced.

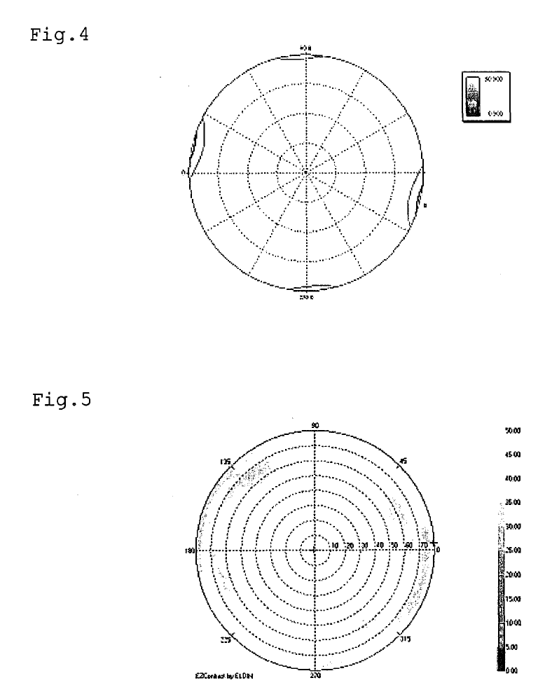

Regarding the viewing angle dependency of a contrast of the liquid crystal display apparatus using such a liquid crystal panel, a computer simulation was conducted. FIG. 4 shows the results. Further, a measurement of the viewing angle dependency of a contrast of the liquid crystal display apparatus produced using the liquid crystal panel thus obtained was performed. FIG. 5 shows the results.

### Example 2

### Production of Laminated Optical Film C

A laminated optical film C was produced in the same way as in the laminated optical film B except that the following film was used as a first optical compensation layer, and that Rth₂ of the second optical compensation layer was −140 nm.

### (First Optical Compensation Layer)

A long norbornene-based resin film (Zeonor (trade name) manufactured by Zeon Corporation, thickness: 60 μm, photoelastic coefficient: 3.1×10⁻¹² m²/N) was subjected to fixed-end biaxial stretching by 1.7 times at 150° C., whereby a long-shaped film was produced. The in-plane retardation Re₁ of the film was 120 nm, the thickness direction retardation Rth₁ thereof was 156 nm, and the Nz coefficient (Rth₁/Re₁) thereof was 1.3. The obtained film was punched to a size corresponding to the liquid crystal cell described above to obtain a first optical compensation layer.

(Production of Liquid Crystal Panel)

A liquid crystal panel was obtained in the same way as in Example 1, except for using the laminated optical film C instead of the laminated optical film B.

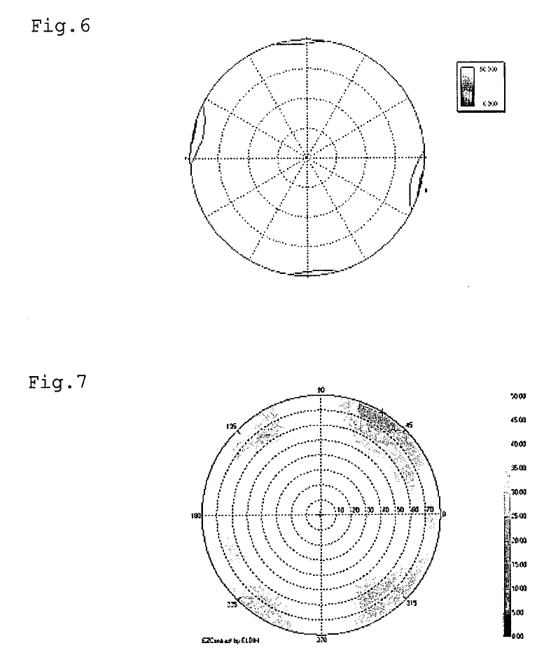

Regarding the viewing angle dependency of a contrast of the liquid crystal display apparatus using such a liquid crystal panel, a computer simulation was conducted. FIG. 6 shows the results. Further, a measurement of the viewing angle dependency of a contrast of the liquid crystal display apparatus produced using the liquid crystal panel thus obtained was performed. FIG. 7 shows the results.

### Example 3

### Preparation of Adhesive Aqueous Solution)

100 parts by weight of a polyvinyl alcohol-based resin containing an acetoactyl group (average polymerization degree: 1,200, saponification degree: 98.5 mol %, acetoacetylation degree: 5 mol %) and 50 parts by weight of methylol melamine were dissolved in pure water under a temperature condition of 30° C., whereby an aqueous solution with a solid content concentration adjusted to 3.7% was obtained. 18 parts by weight of an alumina colloid aqueous solution (average particle size: 15 nm, solid content concentration: 10%, positive charge) were added to 100 parts by weight of the aqueous solution to prepare an adhesive aqueous solution. The adhesive aqueous solution had a viscosity of 9.6 mPa·s. The pH of the adhesive aqueous solution was 4 to 4.5.

(Production of Laminated Optical Film C′)

A polyvinyl alcohol film was dyed in an aqueous solution containing iodine, and thereafter, the resultant film was uniaxially stretched by 6 times between rolls having different speeds in an aqueous solution containing boric acid to obtain a polarizer. A triacetylcellulose film (KC4UYW (trade name)) was attached as a second protective layer on one surface of the polarizer via a polyvinyl alcohol-based adhesive (thickness: 0.1 μm). Then, the adhesive aqueous solution obtained above was applied to the other surface of the polarizer to a thickness of 0.1 μm, and the first optical compensation layer obtained in Example 2 was attached. At this time, the first optical compensation layer was laminated so that the slow axis of the first optical compensation layer was perpendicular to the absorption axis of the polarizer. Thus, a laminate I was obtained.

A liquid crystal fixed layer (Rth₂: −140 nm) to be a second optical compensation layer was attached to the first optical compensation layer side of the laminate I with an isocyanate-based adhesive (thickness: 5 μm), and the base (norbornene-based resin film) was removed, whereby a laminate II in which the second optical compensation layer was transferred to the laminate I was obtained. The laminate 2 obtained in Example 1 was laminated on the second optical compensation layer side of the laminate II via an acrylic pressure-sensitive adhesive (thickness: 12 μm). At this time, the laminate 2 was laminated so that the third optical compensation layer of the laminate 2 was placed on the laminate II side. Further, the laminate 2 was laminated so that the slow axis of the third optical compensation layer was 45° in a clockwise direction with respect to the absorption axis of the polarizer. Thus, a laminated optical film C′ was produced.

(Production of Liquid Crystal Panel)

A liquid crystal panel was obtained in the same way as in Example 2, except for using the laminated optical film C′instead of the laminated optical film C.

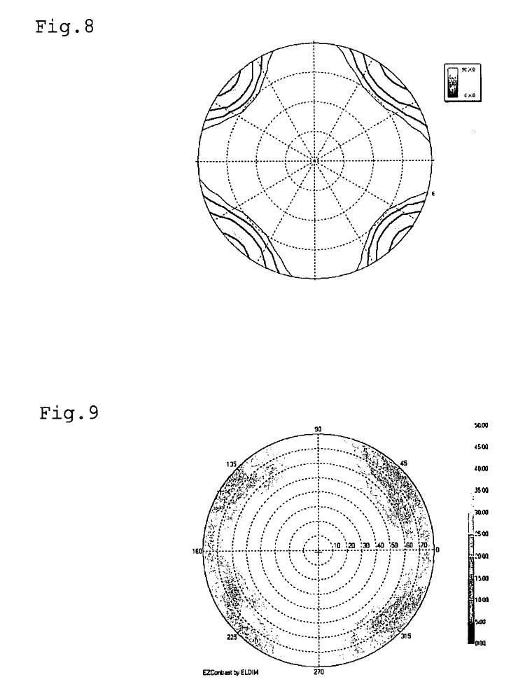

Regarding the viewing angle dependency of a contrast of the liquid crystal display apparatus using such a liquid crystal panel, a computer simulation was conducted. FIG. 8 shows the results. Further, a measurement of the viewing angle dependency of a contrast of the liquid crystal display apparatus produced using the liquid crystal panel thus obtained was performed. FIG. 9 shows the results.

### Comparative Example 1

A liquid crystal panel was obtained in the same way as in Example 1, except for using the laminated film A instead of the laminated optical film B.

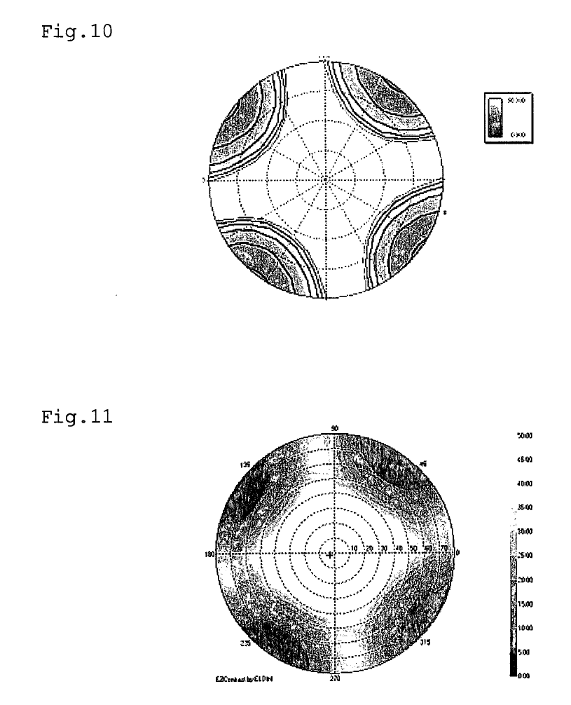

Regarding the viewing angle dependency of a contrast of the liquid crystal display apparatus using such a liquid crystal panel, a computer simulation was conducted. FIG. 10 shows the results. Further, a measurement of the viewing angle dependency of a contrast of the liquid crystal display apparatus produced using the liquid crystal panel thus obtained was performed. FIG. 11 shows the results.

### Comparative Example 2

### Production of Laminated Film D

A laminated film D was produced in the same way as in the laminated optical film B except that the first optical compensation layer and the polarizing plate were laminated so that the slow axis of the first optical compensation layer and the absorption axis of the polarizer were parallel (0°) to each other.

(Production of Liquid Crystal Panel)

A liquid crystal panel was obtained in the same way as in Example 1, except for using the laminated film D instead of the laminated optical film B.

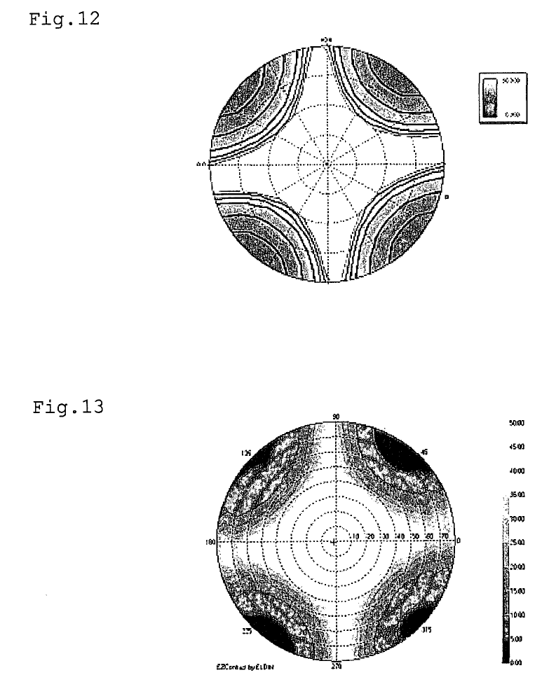

Regarding the viewing angle dependency of a contrast of the liquid crystal display apparatus using such a liquid crystal panel, a computer simulation was conducted. FIG. 12 shows the results. Further, a measurement of the viewing angle dependency of a contrast of the liquid crystal display apparatus produced using the liquid crystal panel thus obtained was performed. FIG. 13 shows the results.

### Comparative Example 3

### Production of Laminated Film E

A laminated film E is produced in the same way as in the laminated optical film C except that the first optical compensation layer and the polarizing plate are laminated so that the slow axis of the first optical compensation layer and the absorption axis of the polarizer are parallel (0°) to each other.

(Production of Liquid Crystal Panel)

A liquid crystal panel is obtained in the same way as in Example 1, except for using the laminated film E instead of the laminated optical film B.

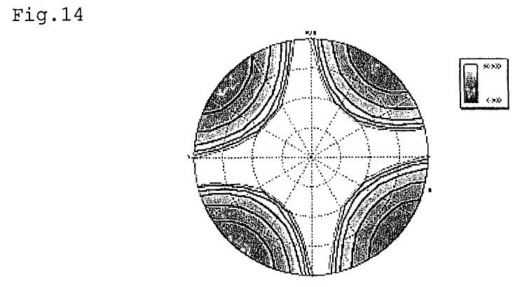

Regarding the viewing angle dependency of a contrast of the liquid crystal display apparatus using such a liquid crystal panel, a computer simulation was conducted. FIG. 14 shows the results.

Table 1 summarizes the whole configurations of the panels in Examples 1 to 3 and Comparative Examples 1 to 3. Table 1 also shows an angle (counterclockwise direction) when the absorption axis of the polarizer on the backlight side is set to be 0°.

TABLE 1

| Example 1 | | | Example 2 | | | Example 3 | | |
|---|---|---|---|---|---|---|---|---|
| A | Second protective | — | A | Second protective | — | A | Second protective | — |
| | layer | | | layer | | | layer | |
| | Polarizer | 90 | | Polarizer | 90 | | Polarizer | 90 |
| | First protective layer | — | | First protective layer | — | | First protective | — |
| | | | | | | | layer | |
| | Fifth optical | 135 | | Fifth optical | 135 | | Fifth optical | 135 |
| | compensation layer | | | compensation layer | | | compensation layer | |
| | Fourth optical | — | | Fourth optical | — | | Fourth optical | — |
| | compensation layer | | | compensation layer | | | compensation layer | |
| VA cell | | | VA cell | | | VA cell | | |
| B | Fourth optical | — | C | Fourth optical | — | C′ | Fourth optical | — |
| | compensation layer | | | compensation layer | | | compensation layer | |
| | Third optical | 45 | | Third optical | 45 | | Third optical | 45 |
| | compensation layer | | | compensation layer | | | compensation layer | |
| | Second optical | — | | Second optical | — | | Second optical | — |
| | compensation layer | | | compensation layer | | | compensation layer | |
| | First optical | 90 | | First optical | 90 | | First optical | 90 |
| | compensation layer | | | compensation layer | | | compensation layer | |
| | First protective layer | — | | First protective layer | — | | — | — |
| | Polarizer | 0 | | Polarizer | 0 | | Polarizer | 0 |
| | Second protective | — | | Second protective | — | | Second protective | — |
| | layer | | | layer | | | layer | |
| Comparative Example 1 | | | Comparative Example 2 | | | Comparative Example 3 | | |
| A | Second protective | — | A | Second protective | — | A | Second protective | — |
| | layer | | | layer | | | layer | |
| | Polarizer | 90 | | Polarizer | 90 | | Polarizer | 90 |
| | First protective layer | — | | First protective layer | — | | First protective | — |
| | | | | | | | layer | |
| | Fifth optical | 135 | | Fifth optical | 135 | | Fifth optical | 135 |
| | compensation layer | | | compensation layer | | | compensation layer | |
| | Fourth optical | — | | Fourth optical | — | | Fourth optical | — |
| | compensation layer | | | compensation layer | | | compensation layer | |
| VA cell | | | VA cell | | | VA cell | | |
| A | Fourth optical | — | D | Fourth optical | — | E | Fourth optical | — |
| | compensation layer | | | compensation layer | | | compensation layer | |
| | Fifth optical | 45 | | Third optical | 45 | | Third optical | 45 |
| | compensation layer | | | compensation layer | | | compensation layer | |
| | — | — | | Second optical | — | | Second optical | — |
| | | | | compensation layer | | | compensation layer | |
| | — | — | | First optical | 0 | | First optical | 0 |
| | | | | compensation layer | | | compensation layer | |
| | First protective layer | — | | First protective layer | — | | First protective | — |
| | | | | | | | layer | |
| | Polarizer | 0 | | Polarizer | 0 | | Polarizer | 0 |
| | Second protective | — | | Second protective | — | | Second protective | — |
| | layer | | | layer | | | layer | |

As is apparent from FIGS. 4 to 14, the liquid crystal panels in Examples 1 to 3 of the present invention were excellent in contrast, compared with the liquid crystal panels in Comparative Examples 1 to 3. It is understood from the comparison between Example 1 and Comparative Example 2 and between Examples 2 and 3 and Comparative Example 3 that a contrast becomes remarkably excellent when the slow axis of the first optical compensation layer and the absorption axis of the polarizer are placed so as to be perpendicular to each other. Further, it was confirmed that the liquid crystal panels in the examples of the present invention had a smaller color shift, compared with the liquid crystal panels in the comparative examples.

### INDUSTRIAL APPLICABILITY

The laminated optical film, the liquid crystal panel, and the liquid crystal display apparatus of the present invention can be applied to a mobile telephone, a liquid crystal television, and the like in a preferred manner.

1. A laminated optical film, comprising, in this order:
a polarizer;
a first optical compensation layer that has a refractive index ellipsoid exhibiting a relationship of nx>ny=nz and an in-plane retardation Re₁ of 80 to 300 nm;
a second optical compensation layer that has a refractive index ellipsoid exhibiting a relationship of nz>nx=ny; and
a third optical compensation layer that has a refractive index ellipsoid exhibiting a relationship of nx>ny=nz and an in-plane retardation Re₃ of 80 to 200 nm,
wherein an absorption axis of the polarizer is perpendicular to a slow axis of the first optical compensation layer.

2. A laminated optical film, comprising, in this order:
a polarizer;
a first optical compensation layer that has a refractive index ellipsoid exhibiting a relationship of nx>ny>nz and an in-plane retardation Re₁ of 80 to 300 nm;
a second optical compensation layer that has a refractive index ellipsoid exhibiting a relationship of nz>nx=ny; and
a third optical compensation layer that has a refractive index ellipsoid exhibiting a relationship of nx>ny=nz and an in-plane retardation Re₃ of 80 to 200 nm,
wherein an absorption axis of the polarizer is perpendicular to a slow axis of the first optical compensation layer.

3. A laminated optical film according to claim 1, further comprising a fourth optical compensation layer that is placed on a side of the third optical compensation layer opposite to the second optical compensation layer and has a refractive index ellipsoid exhibiting a relationship of nx=ny>nz.

4. A liquid crystal panel, comprising a liquid crystal cell and a laminated optical film according to claim 1.

5. A liquid crystal panel according to claim 4, wherein the laminated optical film is placed on a backlight side.

6. A liquid crystal panel according to claim 5, wherein a laminated film including a polarizer and a fifth optical compensation layer that has a refractive index ellipsoid exhibiting a relationship of nx>ny=nz and an in-plane retardation Re₅ of 80 to 200 nm is placed on a viewer side.

7. A liquid crystal panel according to claim 4, wherein the liquid crystal cell is in a VA mode.

8. A liquid crystal display apparatus having a liquid crystal panel according to claim 4.
